(19) United States
(12) Patent Application Publication
(10) Pub. No.: US 2004/0101673 A1
(43) Pub. Date: May 27, 2004

(54) Apparatus and method for transferring a template

(76) Inventor: Robert P. Schoppman, Brandon, FL (US)

Correspondence Address: Robert F. Frijouf, FRIJOUF, RUST & PYLE, P.A., 201 East Davis Boulevard, Tampa, FL, 33606, US

(21) Appl. No.: 10/716,018

(22) Filed: Nov. 18, 2003

Related U.S. Application Data
(63) Continuation of application No. 09/586,292, filed on Jun. 2, 2000, now abandoned.
(60) Provisional application No. 60/138,142, filed on Jun. 8, 1999.

(51) Int. Cl. B32B 7/12

(52) U.S. Cl. 428/317.3; 156/230; 428/354

(57) ABSTRACT

An improved transfer apparatus and method is disclosed for transferring a template of an object from a first surface to a second surface. The transfer apparatus comprises a foam member having a first and a second side with a weak adhesive disposed on the first side of the foam member and a strong adhesive disposed on the second side of the foam member. The foam member is fashionable in the shape of the object for creating a template and is temporarily affixed to the first surface by the weak adhesive of the foam member. The template is transferred from the first surface to the second surface upon engagement of the second surface with the strong adhesive of the foam member. The withdrawal of the second surface from the first surface detaches the template from the first surface for transferring the template from the first surface to the second surface.

### BACKGROUND OF THE INVENTION

1. Field of the Invention

This invention relates to the marking of an object and more specifically, this invention relates to an apparatus and a method for transferring a marking from a first surface to a second surface.

2. Prior Art Statement

There is a need in the construction industry to precisely identify the location of openings in panels, such as wall panels countertops, roof sheathing and the like. Among the typical hardware items requiring openings include switch boxes, electrical outlets, dryer vents, fresh water and drain openings, plumbing stacks, recessed lighting fixtures and the like. Additionally, window and door frames require precise positioning on wall panels. Typically, the panels are fashioned from plywood, wall panel board, sheetrock, particle board, drywall and the like. In the alternative, the panels may be fabricated or covered with a ceramic or other types of tile. The hardware item is affixed to a supporting stud of the building structure. The panels are affixed to supporting studs of the building structure.

The traditional method of locating the desired openings in the panel comprised taking measurements from reference points on the support studs, and transferring these measurements to the panel. The difficulty in accurately measuring and transferring the dimensions to the panel should be apparent to those skilled in the art. Errors in the original and final measurements as well as mistakes in location of reference points on the panel contribute to wasted materials and wasted time.

Various methods have been established by the prior art that minimizes the problems associated with locating openings in panels. Templates have been utilized in a multitude of applications for locating the desired openings in the panel. The template is affixed to the hardware item or place outlining the window or door opening. The panel is placed proximate the studs and the template is transferred to the panel for locating the precise opening in the panel.

Several template styles have been taught by the prior art. These templates can be classified into two general categories. The first classification of template is a mechanical transfer type template. In the mechanical transfer type templates, the mechanical template is temporarily affixed to a first surface. The mechanical template is transferred totally from a first surface to a second surface when the second surface contacts the first surface.

The second classification of template is a marking template. In the marking template, the marking template is affixed to a first surface. The marks of the marking template on the first surface is transferred to the second surface when the second surface comes in contact with the first surface.

The mechanical template typically comprises mechanical means having raised points on the template which produce corresponding depressions in the second surface when the second surface comes in contact with the first surface. The marking template mechanism typically comprises a chemical means such as an ink, dye, paint or the like.

U.S. Pat. No. 3,526,947 to Pasek teaches a template designed to be transferable from a member to a support. The template has a first securing means for removably securing the template to a member. A second securing means is provided on the template for securing it on the reverse side of the template to a support. The latter securing means having greater mechanical strength than the mechanical strength of the first securing means, causing the template to be transferable from the member to the support.

U.S. Pat. No. 4,345,381 to Brislin teaches a universal measuring template for use in place marking and locating utility outlet openings, window land door cutouts and the like in construction panels. The template comprises a perforated carrier having a film of an adhesive applied to one face. The perforations in the carrier control the ratio of adhesive areas exposed to one transfer surface. A gauge variation is developed within the template by the thickness of material used and the adhesive film. A first adhesive bond is created utilizing the least adhesive area exposed through the perforations on one surface of the template. A second adhesive bond is created utilizing the greatest adhesive covered area on the other surface. The first adhesive bond is developed on a utility box perimeter or other surface area and the second bond is developed on a building panel. A greater bond is developed on the building panel surface due to the greater adhesive covered surface area being extended to the panel surface. Thus, when the template is adhered to a utility box perimeter or other surface the bond created will not be as great as the bond which will be created on the blind side of a building panel when the building panel is pressed against the template. By this construction the template will readily transfer from a utility box or other surface to a building panel.

U.S. Pat. No. 4,372,050 to Eisenhauer teaches a template construction for marking a portion to be cut out of a panel. Consisting of a sheet of flexible planar material having a central portion of a predetermined shape, tabs are formed integrally with the central portion, with pressure-sensitive adhesive on the central portion and the tabs. Backing material on the pressure-sensitive material, V-shaped cutouts are provided and a line of demarcation between the central portion and the tabs facilitate bending back of the tabs relative to the central portion. Cuts in the backing material at the lines of demarcation permit the backing material to be removed from the tabs prior to removing the backing material from the central portion.

U.S. Pat. No. 5,157,844 to Mailison and Orton teaches a system for positioning and blind marking construction material panels. The system includes clips designed to support marking projections relative to installed construction components such as electrical outlet boxes and frames for windows and doors. A leg flexure of each clip is used to secure the clip to thin walled components. Each of the clips further has alignment projections that abut the component edges, for securely positioning the clips. The flexure legs break away to enable use of the clip on thick walled components, with an adhesive retaining the clip in lieu of the leg flexure. The system further includes stabilizers for aligning an unsecured panel in parallel spaced apart relation to a previously installed panel. These stabilizers are used to edge-align the panels for precise placement of markings on an inside surface of the panel to be installed.

Although the aforementioned prior art methods provided definite improvements over existing panel marking systems, these prior art processes did have a major disadvantage. The major disadvantage of these prior art methods was the difficulty in fashioning the template into complex shapes.

Therefore, it is an object of the present invention to provide an improved transfer apparatus that overcomes the disadvantages of the prior art and provides a substantial contribution to the panel marking art.

Another object of this invention is to provide an improved transfer apparatus wherein the transfer apparatus may be used for transferring the position of objects in either vertical or horizontal panels.

Another object of this invention is to provide an improved transfer apparatus wherein the transfer apparatus may be used for transferring the position of screw holes, doors, windows, electrical outlets, pipes, vents and the like.

Another object of this invention is to provide an improved transfer apparatus wherein the transfer apparatus is readily adaptable to a wide variety of uses for a wide variety of shapes and materials by merely fashioning the transfer apparatus and without the need to modify the transfer apparatus.

Another object of this invention is to provide an improved transfer apparatus wherein the transfer apparatus is suitable for use on tile.

Another object of this invention is to provide an improved transfer apparatus wherein the transfer apparatus comprises a flexible foam strip having a weak adhesive disposed on a first side of the foam strip and a strong adhesive disposed on a second side of the foam member.

Another object of this invention is to provide an improved transfer apparatus comprising a flexible foam strip that may be cut into pieces and assembled to be fashioned to follow the outline of complex shapes.

Another object of this invention is to provide an improved transfer apparatus comprising a flexible foam strip that may be bent to follow the outline of complex shapes.

Another object of this invention is to provide an improved transfer apparatus comprising a flexible foam strip wherein only the material needed for the template is used thereby minimizing any waste of the flexible foam strip.

Another object of this invention is to provide an improved transfer apparatus that is easy and economical to use by unskilled workers.

The foregoing has outlined some of the more pertinent objects of the present invention. These objects should be construed as being merely illustrative of some of the more prominent features and applications of the invention. Many other beneficial results can be obtained by applying the disclosed invention in a different manner or modifying the invention with in the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention relates to an improved transfer apparatus and method for transferring a template of an object from a first surface to a second surface. The transfer apparatus comprises a foam member having a first and a second side with a weak adhesive disposed on the first side of the foam member and a strong adhesive disposed on the second side of the foam member. The strong adhesive has greater adhesive strength than the weak adhesive. The foam member is fashionable in the shape of the object for creating a foam template. The foam template is temporarily affixed to the first surface by the weak adhesive of the foam member. The foam template is transferred from the first surface to the second surface upon engagement of the second surface with the strong adhesive of the foam member. The second surface is detached from the first surface for transferring the foam template from the first surface to the second surface.

In a more specific embodiment of the invention, the transfer apparatus comprises a flexible foam member for enabling the flexible foam member to be bent to form a foam template of a complex object.

In another embodiment of the invention, a first and a second removable protective strip is disposed on the first side and the second side of the foam member, respectively, for preventing the first and the second sides of the foam member from adhering to a surface prior to removal of the protective strips.

In a preferred embodiment of the invention, the foam member comprises a rectangular cross-section for enabling the foam member to be bent and fashioned into the shape of the object.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is a front view of a first embodiment of a transfer apparatus of the present invention illustrating partial removal of both a first and a second protective covering strip;

FIG. 2 is a side view of FIG 1;

FIG. 3 is a perspective view of a section of wall studs including a duplex electrical receptacle box fastened to a wall stud and a wallboard panel;

FIG. 4 is a magnified view of FIG. 3;

FIG. 5 is a view similar to FIG. 3 illustrating the first embodiment of the transfer apparatus of the present invention affixed to the face of the duplex electrical receptacle box and removal of a second protective covering strip;

FIG. 6 is a magnified view of FIG. 5;

FIG. 7 is a view similar to FIG. 5 illustrating the first embodiment of the transfer apparatus of the present invention affixed to the face of the duplex electrical receptacle box and in contact with the adverse side of a wallboard panel;

FIG. 8 is a view similar to FIG. 5 illustrating the first embodiment of the transfer apparatus of the present invention transferred from the face of the duplex electrical receptacle box to the adverse side of the wallboard panel;

FIG. 9 is a view similar to FIG. 8 illustrating the first embodiment of the transfer apparatus being transferred from the face of the duplex electrical receptacle box to the adverse side of the wallboard panel and the wallboard panel being trimmed to produce an aperture matching the pattern of the electrical receptacle box as transferred by the present invention;

FIG. 10 is a view similar to FIG. 9 illustrating the trimmed wallboard of FIG. 9 installed on a section of wall studs with the aperture in the wallboard aligned with duplex electrical receptacle box;

FIG. 11 is a perspective view of a wall and the adverse side of a framed object with the transferring apparatus of the present invention positioned to simulate the position of a frame hanging means of the frame;

FIG. 11A is a magnified view of a portion of FIG. 11;

FIG. 12 is a view similar to FIG. 11 with the frame hanging means in a relaxed position;

FIG. 13 is a view similar to FIG. 12 with the framed object placed in the desired hanging position and in contact with the wall;

FIG. 14 is a view similar to FIG. 13 illustrating the first embodiment of the transfer apparatus of the present invention transferred to the wall;

FIG. 15 is a view similar to FIG. 14 illustrating a mounting device positioned on the wall proximate the position of the transfer apparatus of the present invention located on the wall;

FIG. 16 is a view similar to FIG. 15 illustrating the framed object hanging in the desired position on the wall;

FIG. 17 is a perspective view of a section of wall studs including a variety of objects fastened to wall studs;

FIG. 18 is a magnified view of a portion of FIG. 17 illustrating the first embodiment of the transfer apparatus of the present invention fashioned in a complex shape;

FIG. 19 is a front view of a second embodiment of a transfer apparatus of the present invention illustrating partial removal of both a first and a second protective covering strip;

FIG. 20 is a side view of a portion of FIG. 19; and

FIG. 21 is a sectional view along line 21-21 in FIG. 19.

Similar reference characters refer to similar parts throughout the several Figures of the drawings.

### DETAILED DISCUSSION

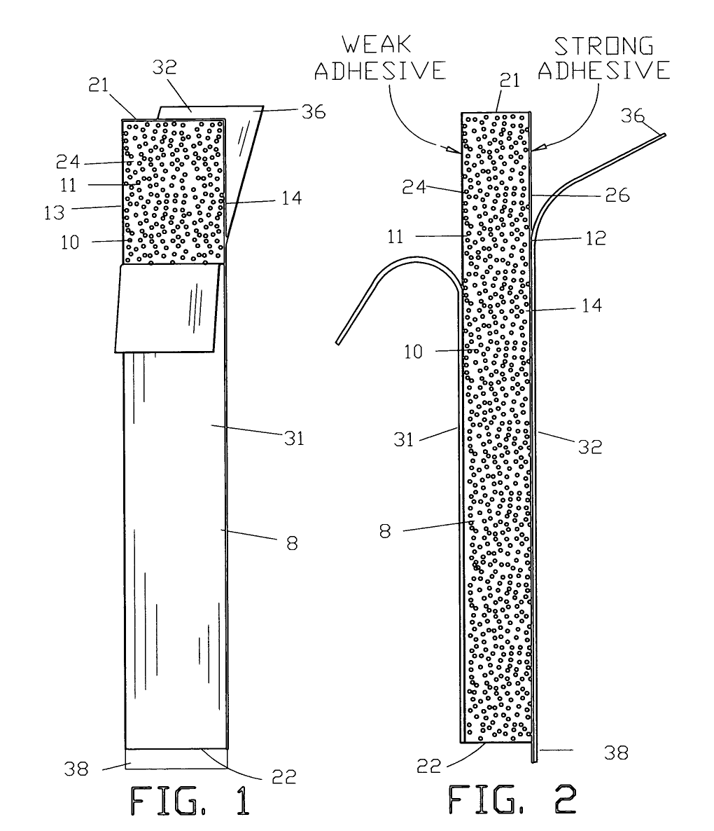

FIGS. 1 and 2 are front and side views of a first embodiment of the transfer apparatus 8 of the present invention comprising a foam member 10. Preferably, the foam member 10 is a resilient open cell foam capable of being cut into segments and being bent to fashion the foam member 10 into a variety of shapes. The foam member 10 comprises a first and a second side 11 and 12 and a first and a second edge 13 and 14. Although the foam member 10 is shown extending between a first and a second end 21 and 22, it should be understood that the foam member 10 may be substantially continuous such as being disposed on a roll (not shown).

The foam member 10 is formed from a resiliently compressible foam material. The resiliently compressible foam material has a thickness sufficient to accommodate for variations in the surfaces that the foam member 10 is affixed to as will be hereafter described. Preferably, the foam member 10 has a thickness between 0.0675 inches and 0.25 inches.

A weak adhesive 24 is disposed on the first side 11 of the foam member 10 and a strong adhesive 26 is disposed on the second side 12 of the foam member 10. A first and a second protective covering strip 31 and 32 are located on the first and second sides 11 and 12 of the foam member 10. The first and second protective covering strips 31 and 32 protect the weak adhesive 24 and the strong adhesive 26, respectively.

The first and second protective covering strips 31 and 32 are illustrated partially removed from the first and second sides 11 and 12 of the foam member 10. The first protective covering strip 31 extends in proximity to the first and second ends 21 and 22 of the foam member 10. The second protective covering strip 32 extends past the first and second ends 31 and 32 of the foam member 10 for defining a first and a second overlapping tab 36 and 38, respectively. These first and second overlapping tabs 36 and 38 provide a convenient means for identifying and removing the second protective covering strip 32. Additionally, the first and second protective covering strips 31 and 32 may comprise differing colors, enabling the user to easily discern the first and second sides 11 and 12 of foam member 10.

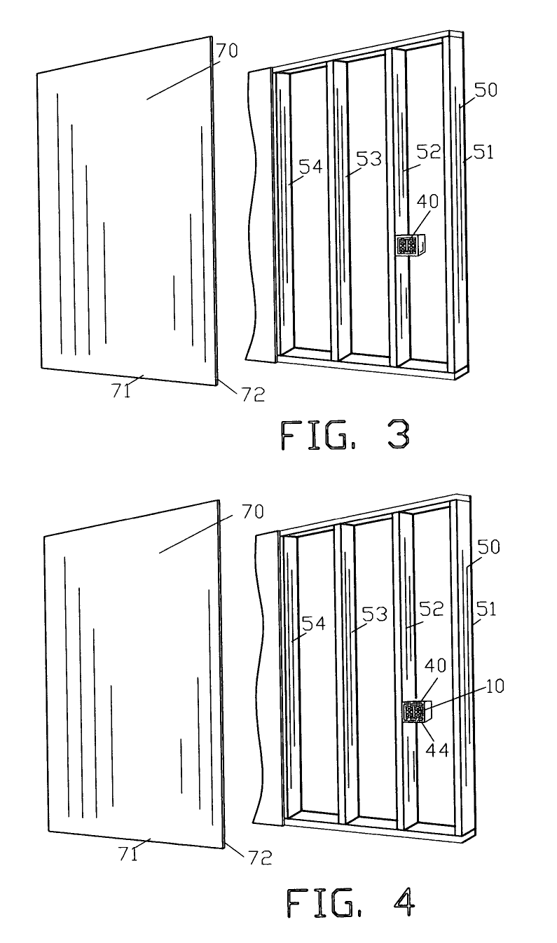

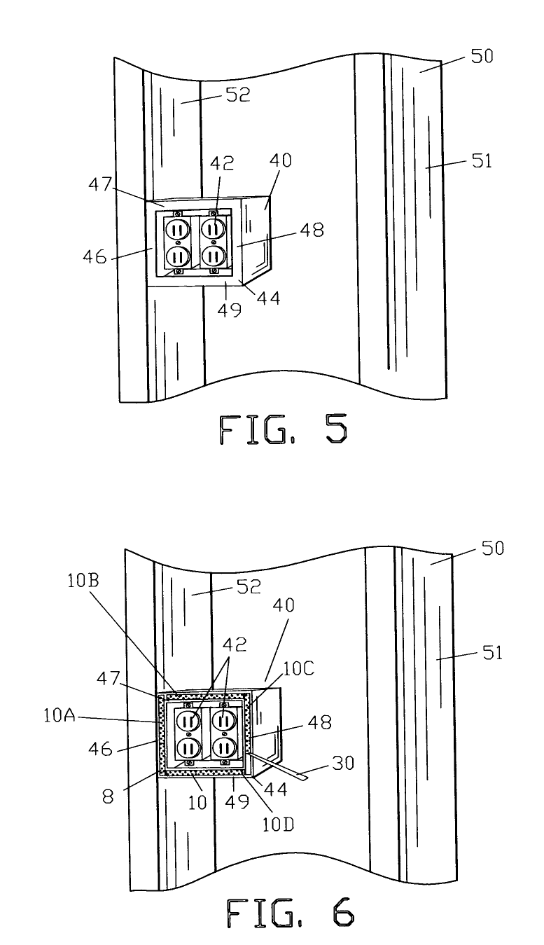

FIGS. 3 and 5 are perspective and magnified views of a duplex electrical receptacle box 40 with electrical receptacles 42 located therein. The duplex electrical receptacle box 40 comprises a face 44 of the duplex electrical receptacle box 40 defined by first through fourth sides 46-49.

A wall 50 is formed from a plurality of wall studs shown as first through fourth wall studs 51-54. The electrical receptacle box 40 is fastened to the second wall stud 52 adjacent to the first wall stud 51.

A wallboard panel 70 is shown positioned adjacent to the wall 50 formed from the plurality of wall studs 51-54. The wallboard panel 70 defines a facing side 71 and an adverse side 72. The wallboard panel 70 is representative of a panel wallboard, plywood, sheetrock, particle board, drywall and the like.

FIGS. 4 and 6 are views similar to FIGS. 3 and 5 illustrating the first embodiment of the transfer apparatus 8 of FIGS. I and 2 being temporarily affixed to the face 44 of the duplex electrical receptacle box 40. The first method of temporarily affixing the transfer apparatus 8 to the face 44 of the duplex electrical receptacle box 40 comprises cutting the foam member 10 into four sections 10A-10D. The four sections 10A-10D of the foam member 10 are temporarily affixed to the face 44 defined by first through fourth sides 46-49.

Each of the four sections 10A-10D of the foam member 10 is cut to an appropriate length to fit the first through fourth sides 46-49 of the duplex electrical receptacle box 40. The first protective covering strips 31 are removed from the four sections 10A-10D of the foam member 10 for exposing the weak adhesive 24. The four sections 10A-10D of the foam member 10 are subsequently applied to the duplex electrical receptacle box 40 by applying the weak adhesive 24 disposed on the first side 11 of the four sections 10A-10D of the foam member 10 to the first through fourth sides 46-49 of the duplex electrical receptacle box 40.

The second protective covering strips 32 are removed from each of the four sections 10A-10D of the foam member 10 affixed to the first through fourth sides 46-49 of the duplex electrical receptacle box 40. The removal of the second protective covering strips 32 expose the strong adhesive 26 disposed to the second side 12 of each of the four sections 10A-10D of the foam member 10.

A second method to temporarily affix the foam member 10 to the face 44 of the duplex electrical receptacle box 40 comprises the bending of the foam member 10. The foam member 10 temporarily is affixed by removing the first protective covering strip 31 from the foam member 10. The weak adhesive 24 disposed on the first side 11 of the foam member 10 adhesively affixes foam member 10 to the first side 46 of the duplex electrical receptacle box face 44.

The foam member 10 is subsequently bent and fashioned to fit the second side 47 of the duplex electrical receptacle box face 44 with the weak adhesive 24 adhesively affixing the foam member 10 to the second side 47 of duplex electrical receptacle box face 44.

In the alternative, the foam material of the foam member 10 enables the foam member 10 to be bent around the corners formed at the intersecting sides of the first through fourth sides 46-49 of the duplex electrical receptacle box face 44 without severing the foam member 10.

The foam member 10 is subsequently bent and fashioned to fit the third and fourth sides 48 and 49 of the duplex electrical receptacle box face 44 with the weak adhesive 24 adhesively affixing foam member 10 to the third and fourth sides 48 and 49 of the duplex electrical receptacle box face 44. The remaining foam member 10 not affixed to the duplex electrical receptacle box face 44 is cut away. The second protective covering strip 32 is then removed from foam member 10 for exposing the strong adhesive 26 disposed to the second side 12 of foam member 10.

FIG. 5 is a perspective view of a section of wall comprising the wall studs 51-54 including the duplex electrical receptacle box 40 fastened to second wall stud 52 as previously illustrated in FIG. 3 and a wallboard panel 70, prior to the application of the first embodiment of the transfer apparatus 8.

FIG. 6 is a perspective view of a section of wall studs 51-54 including a duplex electrical receptacle box 40 fastened to the second wall stud 52 as previously illustrated in FIG. 4 and a wallboard panel 70, illustrating the first embodiment of the transfer apparatus 8 affixed to the face 44 of the duplex electrical receptacle box 40, as detailed in FIG. 4.

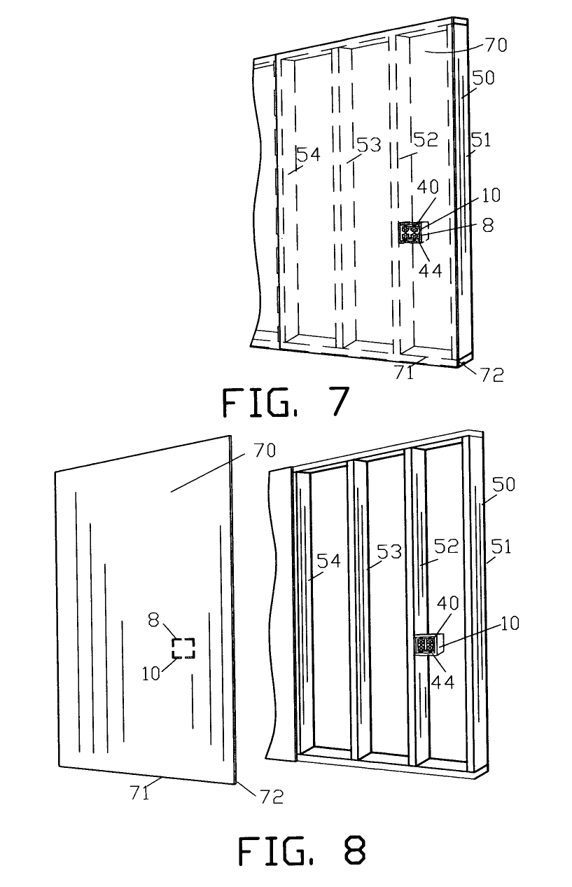

FIG. 7 is a perspective view of the wallboard panel 70 positioned in contact with the wall studs 51-54. The first embodiment of the transfer apparatus 8 temporarily affixed to the face 44 of the duplex electrical receptacle box 40 by the weak adhesive 24. As wallboard panel 70 is positioned proximate wall studs 51-54, the adverse side 72 of wallboard panel 70 contacts the second side 12 of the foam member 10 of the first embodiment of the transfer apparatus 8. The strong adhesive 26 disposed to second side 12 of foam member 10 forms a strong adhesive bond with the adverse side 72 of wallboard panel 70.

FIG. 8 is a perspective view of the wallboard panel 70 positioned away from the wall studs 51-54. As wallboard panel 70 is moved from direct contact with face 44 of the duplex electrical receptacle box 40, the strong adhesive bond with the adverse side 72 of wallboard panel 70 from the strong adhesive 26 overcomes the weak adhesive bond between weak adhesive 24 and the face 44 of the duplex electrical receptacle box 40. The thickness and the resilient compressibility of the foam member 10 accommodate for any variations between the first through fourth sides 46-49 of the duplex electrical receptacle box 40 and the wallboard panel 70.

The movement of the wallboard panel 70 from the wall studs 51-54 transfers the foam member 10 from the face 44 of the duplex electrical receptacle box 40 to the adverse side 72 of the wallboard panel 70.

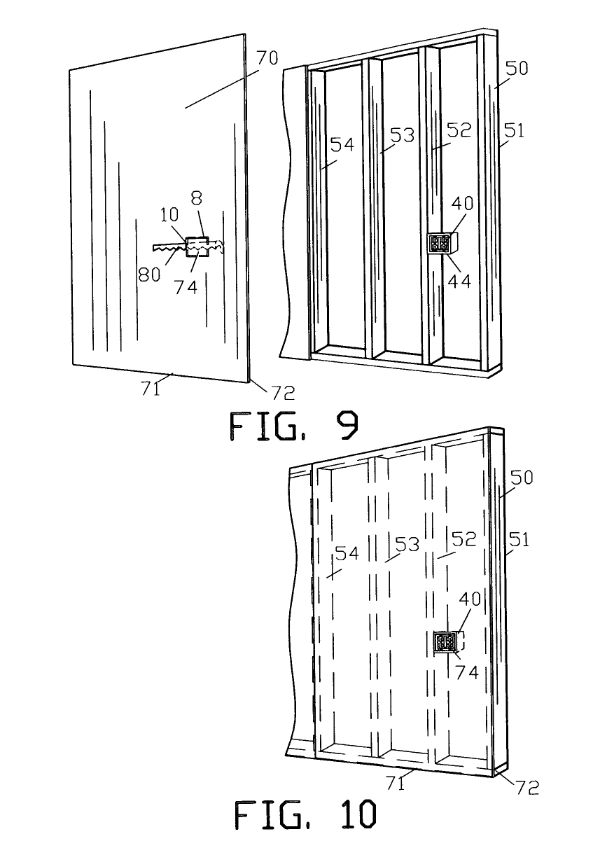

FIG. 9 is a perspective view of the wallboard panel 70 positioned away from the wall studs 51-54 with the foam member 10 transferred from the face 44 of the duplex electrical receptacle box 40 to the adverse side 72 of the wallboard panel 70. The wallboard panel 70 is being trimmed by saw 80 to produce an aperture 74 in the wallboard panel 70 to match the shape and relative location of the electrical receptacle box 40 as transferred by the foam member 10. After the wallboard panel 70 is trimmed by saw 80, the foam member 10 may be removed from the wallboard panel 70.

FIG. 10 is a perspective view of the wallboard panel 70 positioned in contact with the wall studs 51-54. The wallboard panel 70 is permanently secured to the wall studs 51-54 with the aperture 74 in the wallboard panel 70 aligned and registered with duplex electrical receptacle box 40.

FIG. 11 is a perspective view of a framed object 110 positioned adjacent to a wall 150. The framed object 110 defines a facing side 111 and an adverse side 112. The framed object 110 is representative of a picture, a photograph, a painting, a decorative item, a shelf, a clock or a similar item affixed to the wall 150.

The framed object 110 comprises a hanger wire 114 affixed to framed object 110 by attachment to hanger eyelets 116. The hanger wire 114 is extended to a position to simulate the position of the hanger wire 114 when supporting the framed object 110.

FIG. 11A is a magnified view of a portion of FIG. 11 illustrating the first embodiment of the transfer apparatus 8 located at the position of the hanger wire 114 when the hanger wire 114 is supporting the framed object 110. The first protective covering strip 31 is removed from the first side 11 of foam member 10 exposing the weak adhesive 24 disposed on the first side 11 of foam member 10. The foam member 10 is then positioned at the location of the hanger wire 114 when the hanger wire 114 is supporting the framed object 110. The weak adhesive 24 affixes the foam member 10 to the adverse side 111 of the framed object 110.

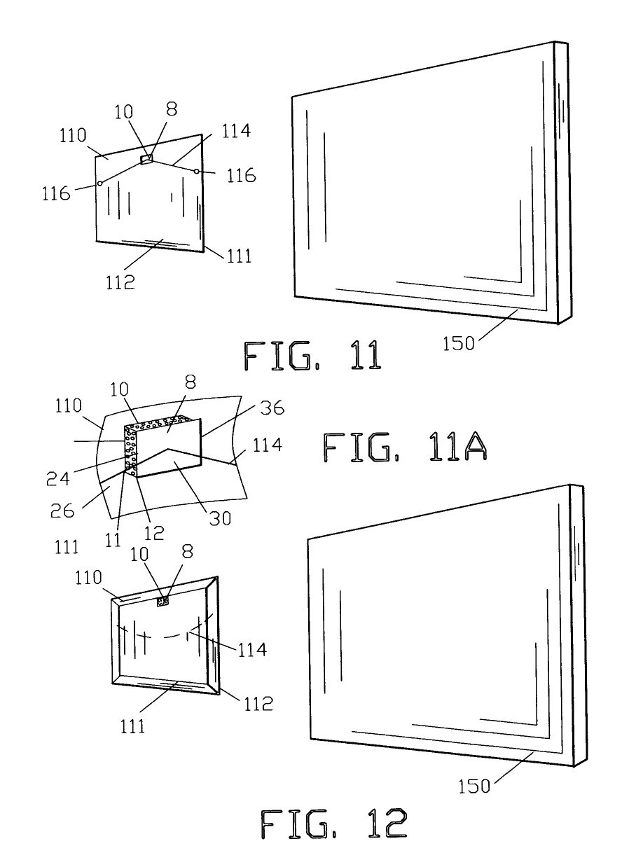

FIG. 12 is a perspective view of the framed object 110 positioned adjacent to the wall 150 with the object hanger wire 114 being in a relaxed position. Second protective covering strip 32 of foam member 10 has been removed for exposing strong adhesive 26 disposed on second side 12 of foam member 10.

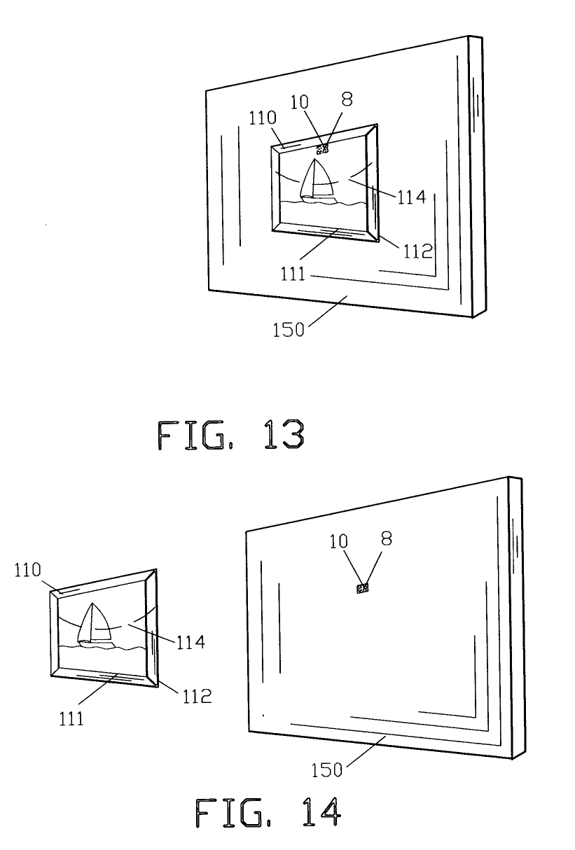

FIG. 13 is a perspective view of the framed object 110 placed in the desired hanging position and in contact with the wall 150. The framed object 110 is moved in proximity to the wall 150 at the desired position of framed object 110 relative to wall 150. When the desired position of framed object 110 relative to wall 150 is determined, the framed object 110 is pressed against wall 150. The strong adhesive 26 disposed to second side 12 of the foam member 10 forms a strong adhesive bond between wall 150 and foam member 10.

FIG. 14 is a perspective view of the framed object 110 positioned away from the wall 150. The first embodiment of the transfer apparatus 8 has been transferred to the wall 150. As the framed object 110 is removed from direct contact with wall 150, the strong adhesive 26 on the second side 12 of foam member 10 overcomes the weak adhesive 24 on the first side 11 of foam member 10 to transfer the foam member 10 from the framed object 110 to wall 150.

FIG. 15 is a perspective view of the framed object 110 positioned away from the wall 150. A mounting device 125 is secured to the wall 150 proximate the position the first embodiment of the transfer apparatus 8 on the wall 150. The foam member 10 as previously illustrated in FIG. 14 identifies the location of the mounting device 125 to provide the desired location of framed object 110. The mounting device 125 is affixed to wall 150 and foam member 10 is removed from wall 150. The mounting device 125 may be a nail, screw, or specialty hanger as is well known to those skilled in the art.

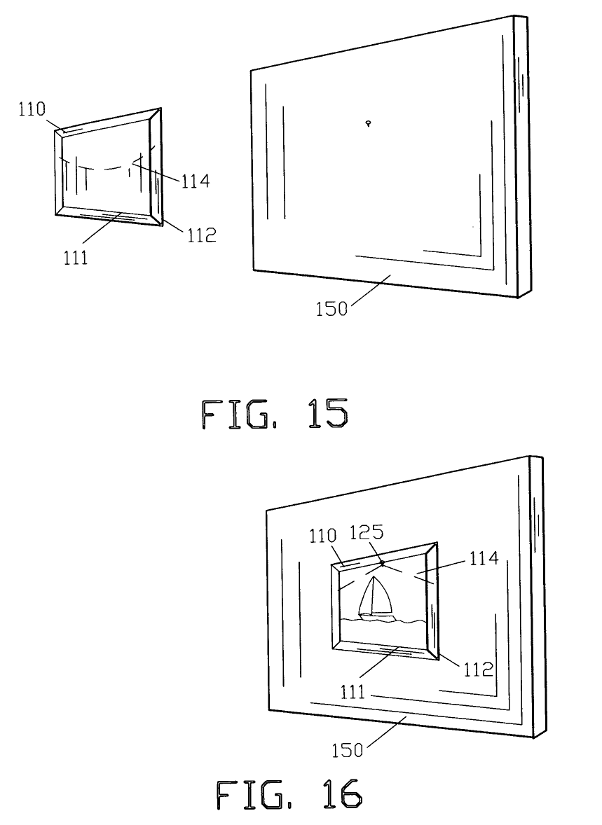

FIG. 16 is a perspective view of the framed object 110 hanging in the desired position on the wall 150. Following the installation of mounting device 125 on wall 150, the framed object 110 is positioned such that hanger wire 114 is positioned to suspend framed object 110 from mounting device 125.

As should be appreciated by those skilled in the art, the framed object represents only one of many objects which may utilize the first embodiment of the transfer apparatus 8 of the present invention for accurately transferring a position on a first surface to a corresponding position on a second surface by forming a template as previously described.

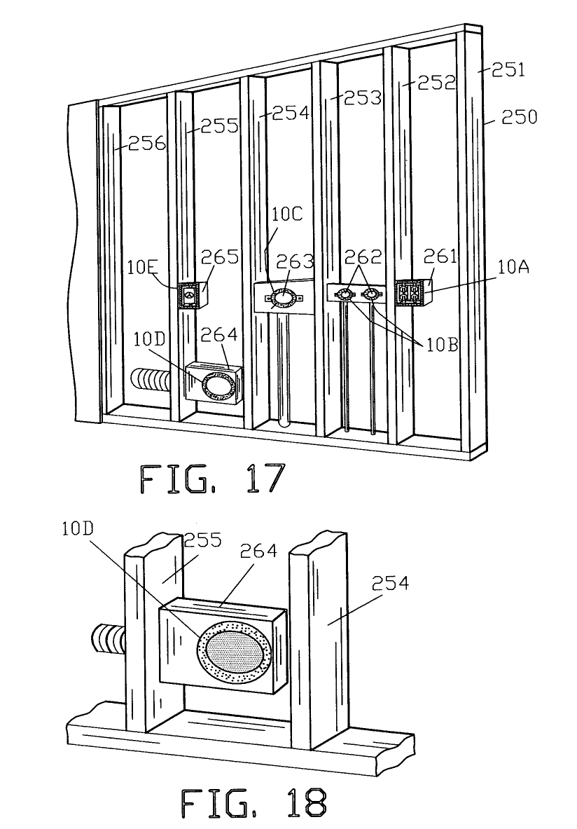

FIG. 17 illustrates a wall 250 formed from a plurality of wall studs 251-256. The first embodiment of the transfer apparatus 8 is utilized simultaneously on a plurality of objects 261-265. Each of the plurality of objects 261-265 is shown having different sizes and/or shapes and being affixed to at least one of the plurality of wall studs 252-255.

The first embodiment of the transfer apparatus 8 is shown as a plurality of foam members 10A-10E for simultaneously transferring a plurality of templates from the plurality of objects 261-265 to a second surface. The plurality of foam members 10A-10E are affixed to the plurality of objects 261-265 by the weak adhesive 24 disposed on first side 11 of foam member 10A-10E.

FIG. 18 is a magnified view of a section of FIG. 17 illustrating the wall studs 254 and 255 and including the objects 264 fastened between wall studs 254 and 255. The objects 264 may be representative of a vent pipe or the like.

The first embodiment of the transfer apparatus 8 is illustrated as a foam member 10D fashioned in a complex shape with the weak adhesive 24 disposed to first side 11 of foam member 10D affixed to the objects 264. The foam member 10D is fashioned in the complex shape with a unitary length of the foam member 10.

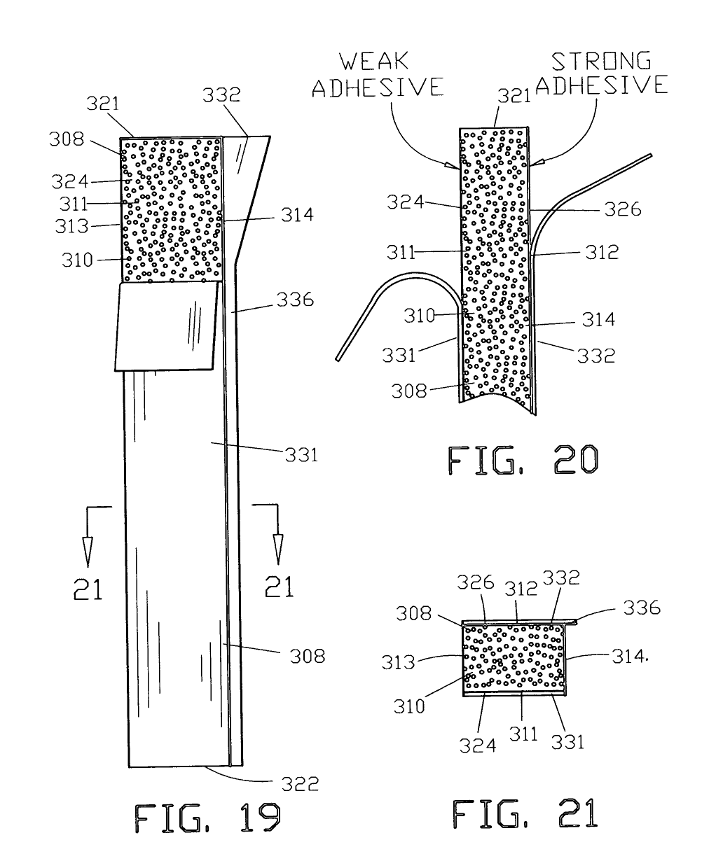

FIGS. 19 and 20 are front and side views of a second embodiment of the transfer apparatus 308 of the present invention comprising a foam member 310. The foam member 310 is capable of being cut into segments and being bent in a manner similar to the foam member 10 as set forth herein.

The foam member 310 comprises a first and a second side 311 and 312 and a first and a second edge 313 and 314. Preferably, the foam member 310 is a substantially continuous roll (not shown).

A weak adhesive 324 is disposed on the first side 311 of the foam member 310 and a strong adhesive 326 is disposed on the second side 312 of the foam member 310. A first and a second protective covering strip 331 and 332 are located on the first and second sides 311 and 312 of the foam member 310 for protecting the weak and strong adhesives 324 and 326, respectively.

The first and second first protective covering strips 331 and 332 are illustrated partially removed from the first and second sides 311 and 312 of the foam member 310. The first and second protective covering strips 331 and 332 extend in proximity to the first and second ends 321 and 322 of the foam member 310.

In this second embodiment of the transfer apparatus 308 of the present invention, the second protective covering strip 332 has a greater width than the foam member 310. The second protective covering strip 332 extends past the second edge 314 of the foam member 310 for defining an overlapping edge 336.

The overlapping edge 336 provides a convenient means for removing the second protective covering strip 332 when the foam member 310 is severed into segments. Each of the severed segments provides an overlapping edge 336 for enabling the convenient removal of the second protective covering strip 332 from the foam member 310. Additionally, the overlapping edge 336 enables an operator to easily discern the first and second sides 311 and 312 of foam member 310.

Although the invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A transfer apparatus for transferring a template of an object from a first surface to a second surface, comprising:
a foam member having a first and a second side;
a weak adhesive disposed on said first side of said foam member;
a strong adhesive disposed on said second side of said foam member;
said strong adhesive having greater adhesive strength than said weak adhesive;
said foam member being fashionable in the shape of the object for creating a foam template thereby;
said foam template being temporarily affixable to the first surface by said weak adhesive of said foam member attaching to the first surface;
said foam template being transferable from the first surface to the second surface upon engagement of the second surface with said strong adhesive of said foam member to affix said foam template to the second surface whereupon the withdrawal of the second surface from the first surface detaches the foam template from the first surface to transfer said foam template from the first surface to the second surface.

2. A transfer apparatus for transferring a template of an object as set forth in claim 1, wherein said foam member comprises a flexible foam member for enabling said flexible foam member to be bent to form a foam template of an complex object.

3. A transfer apparatus for transferring a template of an object as set forth in claim 1, wherein said foam member is a resiliently compressible foam member for accommodating for any variations in the first surface and second surfaces.

4. A transfer apparatus for transferring a template of an object as set forth in claim 1, wherein said foam member has a resiliently compressible thickness for accommodating for any minor variations in the first surface and second surfaces.

5. A transfer apparatus for transferring a template of an object as set forth in claim 1, wherein said foam member has a resiliently compressible thickness between 0.0675 inches and 0.25 inches for accommodating for any minor variations in the first surface and second surfaces.

6. A transfer apparatus for transferring a template of an object as set forth in claim 1, including a first and a second removable protective strip disposed on said first side and said second side of said foam member respectively for preventing said first and said second sides of said foam member from adhering to a surface prior to removal of said protective strips.

7. A transfer apparatus for transferring a template of an object as set forth in claim 1, wherein said foam member comprises a rectangular cross-section for enabling said foam member to be bent and fashioned into the shape of the object.

8. A transfer apparatus for transferring a template of an object as set forth in claim 1, wherein said foam member comprises a rectangular cross-section for enabling said foam member to be bent and fashioned into the shape of the object;
a first removable protective strip disposed on said first side of said foam member for preventing said first side of said foam member from adhering to a surface prior to removal of said protective strip; and
a second removable protective strip disposed on said second side of said foam member for preventing said second side of said foam member from adhering to a surface prior to removal of said protective strip.

9. A transfer apparatus for transferring a template of an object as set forth in claim 1, including a first removable protective strip disposed on said for preventing said first side of said foam member from adhering to a surface prior to removal of said protective strip;
a second removable protective strip disposed on said second side of said foam member for preventing said second side of said foam member from adhering to a surface prior to removal of said protective strip; and
one of said first and second removable protective strips being larger than the other of the first and second removable protective strips for providing a visual indication on the difference between the first and second sides of said foam member.

10. A transfer apparatus for transferring a template of a complex two dimensional object from a first surface to a second surface, comprising:
a flexible foam member having a first and a second side;
said flexible faaom member having a resiliently compressible thickness for accommodating for any minor variations between the first surface and second surfaces;
a weak adhesive disposed on said first side of said flexible foam member;
a strong adhesive disposed on said second side of said flexible foam member;
said strong adhesive having greater adhesive strength than said weak adhesive;
a first removable protective strip disposed to said first side of said flexible foam member for preventing said first side of said flexible foam member from adhering to a surface prior to removal of said first protective strip;
a second removable protective strip disposed to said second side of said flexible foam member for preventing said second side of said flexible foam member from adhering to a surface prior to removal of said second protective strip;
said flexible foam member being fashionable in the shape of complex two dimensional object for creating a foam template thereby;
said foam template being temporarily affixable to the first surface by said weak adhesive of said flexible foam member attaching to the first surface;
said foam template being transferable from the first surface to the second surface upon engagement of the second surface with said strong adhesive of said foam member to affix said foam template to the second surface whereupon the withdrawal of the second surface from the first surface detaches the foam template from the first surface to transfer said foam template from the first surface to the second surface.

11. A method for transferring a template of an object from a first surface to a second surface including a foam member having a first and a second side, a weak adhesive disposed on said first side of said foam member, a strong adhesive disposed on said second side of said foam member said strong adhesive having greater adhesive strength than said weak adhesive, comprising the steps of:
fashioning said foam member in the shape of the object;
temporarily affixing said first side of said foam member to the first surface by said weak adhesive;
engaging the second surface in contact with said second side of said foam member;
withdrawing the second surface from the first surface, wherein said foam member fashioned as a foam template being transferable from the first surface to the second surface upon engagement of the second surface with said strong adhesive of said foam template to affix said foam template to the second surface.

12. A method for transferring a template of an object from a first surface to a second surface including a flexible foam member having a first and a second side, a weak adhesive disposed on said first side of said flexible foam member, a strong adhesive disposed on said second side of said flexible foam member said strong adhesive having greater adhesive strength than said weak adhesive, a first and a second protective strip disposed on said first and said second side, respectively, of said flexible foam member, comprising the steps of:
removing said first protective strip from said first side of said flexible foam member;
fashioning said flexible foam member in the shape of the object;
temporarily affixing said first side of said flexible foam member to the first surface by said weak adhesive;
removing said second protective strip from said second side of said flexible foam member;
engaging the second surface in contact with said second side of said flexible foam member; and
withdrawing the second surface from the first surface, wherein said flexible foam member fashioned as a flexible foam template being transferable from the first surface to the second surface upon engagement of the second surface with said strong adhesive of said flexible foam template to affix said flexible foam template to the second surface.
